(19) United States
(12) Patent Application Publication
(10) Pub. No.: US 2026/0280333 A1
(43) Pub. Date: Sep. 17, 2026

(54) DC UPS WITH AUTO-CONFIGURABLE OUTPUT

(71) Applicant: Schneider Electric IT Corporation, Foxborough, MA (US)

(72) Inventors: Hemant Agrawal, Bangalore (IN); Mark William Kaloudis, Andover, MA (US); Sudhir Shenoy, Bangalore (IN); K Gowri Shenoy, Bangalore (IN)

(21) Appl. No.: 19/561,645

(22) Filed: Mar. 10, 2026

(30) Foreign Application Priority Data
Mar. 11, 2025 (IN) 202511021708

(51) Int. Cl. H02J 9/06; H02M 1/00

(52) U.S. Cl. CPC H02J 9/061; H02M 1/008

(57) ABSTRACT

A power system for converting the voltage of DC power is provided. The power system comprises a DC input configured to receive input DC power having an input voltage; a DC output to provide output DC power to a load; power conversion circuitry; one or more energy-storage device; and at least one controller configured to: control the power conversion circuitry to convert the input DC power into conditioned DC power having a first voltage; and control the power conversion circuitry to provide the output DC power having a second voltage selected based on the input voltage of the input DC power; and control the power conversion circuitry to draw stored energy from the energy-storage device and suitably condition it to provide the output DC power; and control the power conversion circuitry to convert the input DC power into conditioned power to provide the conditioned DC power to the energy-storage device.

### CROSS-REFERENCE TO RELATED APPLICATIONS

This application claims the benefit of priority to Indian Patent Application No. 202511021708, filed on Mar. 11, 2025, entitled “DC UPS WITH AUTO-CONFIGURABLE OUTPUT, ” which is incorporated by reference herein in its entirety.

### TECHNICAL FIELD

At least one example in accordance with the present disclosure relates generally to systems and methods for providing power to loads.

### BACKGROUND

Power devices, such as uninterruptible power supplies (UPSs), may be used to provide regulated, uninterrupted power for sensitive and/or critical loads, such as computer systems and other data-processing systems. Existing UPSs include online UPSs, offline UPSs, line-interactive UPSs, as well as others. UPSs may provide output power to a load. The output power may be derived from a primary source of power, such as a utility-mains source, and/or derived from a back-up source of power, such as an energy-storage device.

### SUMMARY

According to at least one aspect of the present disclosure, a power system for converting the voltage of DC power is presented. The power system comprises a DC input configured to receive input DC power having an input voltage from a power source; a DC output configured to provide output DC power to a load; power conversion circuitry; and at least one controller configured to: control the power conversion circuitry to convert the input DC power into conditioned DC power having a first voltage; and control the power conversion circuitry to provide the output DC power having a second voltage selected based on the input voltage of the input DC power.

In some examples, the power conversion circuitry comprises: a first DC/DC converter coupled to the DC input and configured to provide the conditioned DC power; and a second DC/DC converter coupled to the DC output and configured to provide the output DC power. In some examples, the second DC/DC converter is configured to be coupled to an energy-storage device, and wherein the at least one controller is configured to control the second DC/DC converter to draw stored energy from the energy-storage device and provide the output DC power derived at least in part from the stored energy. In various examples, the at least one controller is further configured to control the second DC/DC converter to set a voltage of the output DC power based on the input voltage of the input DC power at the DC input. In many examples, the at least one controller is further configured to control the second DC/DC converter to provide the output DC power such that the second voltage is within a threshold voltage amount of the input voltage of the input DC power. In some examples, the system further comprises a voltage sensor configured to detect a voltage of the input DC power.

In various examples, the second voltage selected based on the input voltage of the input DC power is approximately equal to the input voltage of the input DC power at the DC input. In some examples, the power system further comprises an energy-storage device, wherein the output DC power is derived from energy stored in the energy-storage device. In various examples, the power conversion circuitry is configured to provide a first portion of the conditioned DC power to the load and a second portion of the conditioned DC power to an energy-storage device. In many examples, controlling the power conversion circuitry to convert the input voltage of the input DC power includes controlling a first DC/DC converter such that the first voltage of the conditioned DC power is different than the input voltage of the input DC power. In some examples, the input DC power is received at a voltage level rated for use by the load. In various examples, the power conversion circuitry is configured to be coupled to an energy-storage device, and wherein the at least one controller is configured to control the power conversion circuitry to provide uninterrupted power derived from the power source or the energy-storage device to the load.

At least one aspect of the present disclosure relates to a method for providing power to a load. The method comprises receiving input DC power; responsive to receiving input DC power, determining a voltage of the input DC power; and responsive to determining the voltage: converting the voltage of the input DC power to a first voltage; providing output DC power having a second voltage based on the voltage of the input DC power.

In various examples, the method further comprises drawing stored energy from an energy-storage device; and converting a voltage of the stored energy to provide the output DC power having the second voltage. In many examples, providing the output DC power having the second voltage includes converting the first voltage so that the second voltage is within a threshold voltage amount of the voltage of the input DC power. In various examples the voltage of the input DC power is rated for use by the load.

According to at least one aspect of the present disclosure, a non-transitory computer-readable medium is presented, the medium storing thereon instructions that, when executed by at least one processor, instruct the at least one processor to: determine a voltage of input DC power; and control power conversion circuitry to: produce conditioned DC power based on the input DC power by converting the voltage of the input DC power to a first voltage for the conditioned DC power; and provide output DC power, the output DC power having a second voltage based on the voltage of the input DC power.

In some examples, the instructions instruct the at least one processor to: control a DC/DC converter to condition the input DC power and provide at least a portion of the conditioned DC power to an energy-storage device. In many examples, the instructions instruct the at least one processor to: control a DC/DC converter to provide the output DC power having the second voltage based on the voltage of the input DC power. In various examples, the instructions instruct the at least one processor to: control a DC/DC converter to set the second voltage of the output DC power to within a threshold amount of the voltage of the input DC power.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 illustrates a block diagram of an auto-configurable uninterruptible power supply (UPS) according to an example;

FIG. 2 illustrates a process for providing power to loads according to an example; and

FIG. 3 illustrates a block diagram of a power system according to an example.

### DETAILED DESCRIPTION

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

Many types of loads, such as home appliances, are designed to be powered by a wall outlet that provides AC utility-grid power. Some loads include, or are sold with, power converters that convert the received AC power to DC power. For example, laptop computers may be sold with an external charging cable and AC/DC converter. The charging cable may be plugged into a wall outlet to draw AC power, and the AC/DC converter may convert the received AC power to DC power to provide to the laptop computer. In some examples, the AC/DC converter may be configured to provide DC power with a particular voltage level to the load (for example, a rated voltage of the load). Although laptop computers are provided as one example of loads, many different types of devices are sold with (or designed to be used with) AC/DC converters to convert received AC power to DC power suitable for the load.

In some examples, a user may wish to connect a load to a power device, such as an uninterruptible power supply (UPS), a power-distribution unit (PDU), and so forth. For example, a DC/DC UPS may be connected between an AC/DC converter, as discussed above, and a DC load to provide uninterruptible power to the DC load. The UPS may be capable of providing uninterruptible output power to the load. In some examples, the output power may have variable voltages. For example, the UPS may be able to provide output power having a DC voltage of 5V, or 6V, or 10V, and so forth. As discussed above, loads may be rated to receive power with certain characteristics, such as DC power at a certain rated voltage. Accordingly, where a UPS is connected between an AC/DC converter and a DC load, it may be advantageous for the UPS to provide output DC power with the rated voltage of the load.

To select between the different voltages, the UPS may be configured manually by a user (for example, the user may enter the desired output voltage level or range, such as by keying in the desired voltage using a keypad or other user interface) or automatically (for example, the UPS may come equipped with a communications relay that allows the UPS to communicate with the load). Example UPSs that can be configured to set an output voltage may use user commands and/or instructs (for example, commands given by the user using a user interface) to determine the appropriate output voltage (for example, where a user manually enters a desired output voltage), or may communicate with a load directly to determine a desired output voltage.

Examples of the present disclosure provide a power system (for example, a UPS) that can automatically determine the output voltage for a connected load. In some examples, the power system may determine the output voltage without a user setting the desired voltage and without communicating with the load. Example power systems may have an input configured to couple to a power source that provides power rated for use by the load (for example, an AC/DC converter configured to be used with the load), and an output configured to couple to a load and provide output power to the load. Example power systems may sense one or more characteristics (for example, voltage) of the input power provided by the power source, and automatically configure the output (for example, a converter) to provide output power rated for the load based on the characteristics of the input power. In some examples, the UPSs disclosed herein may automatically configure the output power characteristics to match the characteristics of the input power. For example, if an AC/DC converter provides DC power with a DC voltage of 12 V to the UPS, the UPS may automatically configure an output converter to provide DC output power with a voltage of 12 V to the load.

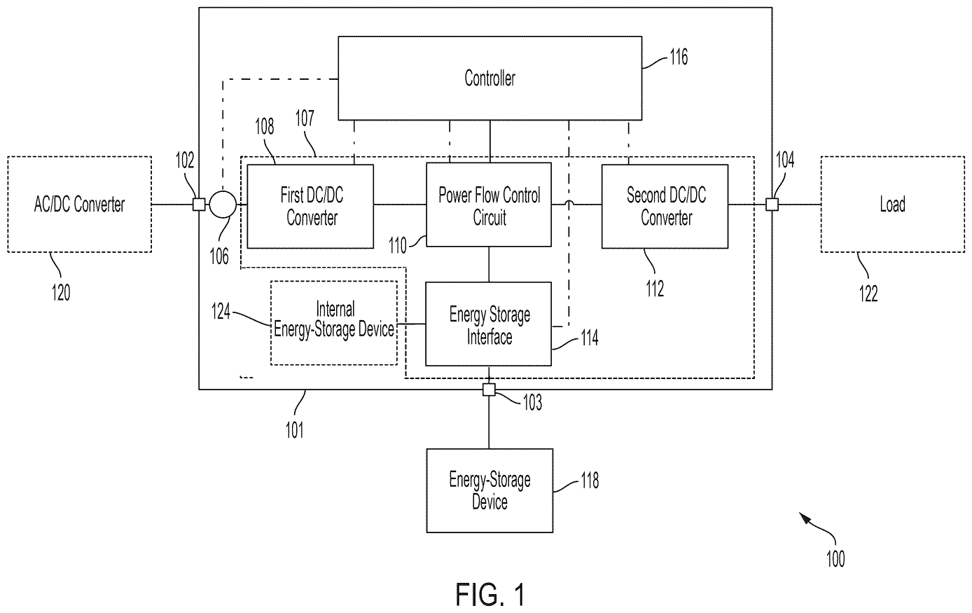

FIG. 1 illustrates a block diagram of a power system 100 having an auto-configurable UPS 101 according to an example. The auto-configurable UPS 101 may automatically determine the voltage of the output power provided to a load such that the load receives output power having a voltage within a range and/or at a level that the load is rated to receive.

The auto-configurable UPS 101 (“UPS 101”) includes an input 102, an output 104, one or more sensors 106 (“sensors 106”), and power conversion circuitry 107. The power conversion circuitry 107 may include a first DC/DC converter 108 (“first converter 108”), a power flow control circuit 110 (“flow circuit 110”), a second DC/DC converter 112 (“second converter 112”), and an energy-storage interface 114. The UPS 101 also includes at least one controller 116 (“controller 116”), an internal energy-storage device 124 (“internal energy-storage device 124”), and may include a bidirectional connection 103. The power system 100 also includes an AC/DC converter 120, one or more loads 122 (“load 122”), and may include one or more energy-storage devices 118 (“energy-storage device 118”).

The input 102 is coupled to the first converter 108 and is configured to be coupled to the AC/DC converter 120. In some examples, the input 102 may also be coupled to one or more of the sensors 106. The first converter 108 is coupled to the input 102 via a first connection and to the flow circuit 110 via a second connection, and may be coupled to one or more of the sensors 106 via the first connection The flow circuit 110 is coupled to the second converter 112 via a first connection, the controller 116 via a second connection, the energy-storage interface 114 via a third connection, and to the first converter 108 via a fourth connection. The second converter 112 is coupled to the output 104 via a first connection and to the flow circuit 110 via a second connection. The output 104 is coupled to the second converter 112 and is configured to be coupled to the load 122. The internal energy-storage device 124 is coupled to the energy-storage interface 114 via a first connection. The energy-storage interface 114 is coupled to the bidirectional connection 103 via a first connection, the flow circuit 110 via a second connection, and the internal energy-storage device 124 via a third connection. The bidirectional connection 103 is coupled to the energy-storage interface 114 and is configured to be coupled to the energy-storage device 118.

The controller 116 may be communicatively coupled to one or more of the sensors 106, the first converter 108, the flow circuit 110, the second converter 112, and/or the energy-storage interface 114. In some examples, the controller 116 may also be communicatively coupled to the energy-storage device 118, the AC/DC converter 120, and/or the load 122.

The input 102 is configured to receive input power. In some examples, the input 102 is configured to receive input DC power. The input 102 may be configured to selectively connect to an AC/DC converter (for example, the AC/DC converter 120), to a DC/DC converter, or to another type of power supply or device capable of providing power. The input 102 may be any type of input, such as a plug, power port, pin, or other type of connection configured to mate with external devices.

The sensors 106 are configured to detect characteristics of one or more parameters of the auto-configurable UPS 101. The parameters may include parameters such as temperature, acoustics, power, and so forth. For example, a sensor may be coupled to the input 102 and configured to detect the voltage, current, and/or other characteristics of power received at the input 102. Accordingly, the sensors 106 may include one or more voltage sensors, one or more current sensors, and so forth. The power may be provided to the input 102 by an external source, such as the AC/DC converter 120. In some examples, the sensors 106 are configured to detect at least the voltage of the input power provided by the AC/DC converter 120 to the input 102.

The first converter 108 is configured to receive the input power and condition the input power into conditioned power. The conditioned power may have characteristics different than the input power. For example, the conditioned power may have a different voltage compared to the input power. The first converter 108 may provide the conditioned power to the flow circuit 110. In some examples, the first converter 108 is a DC/DC converter, meaning the first converter 108 receives DC power and outputs DC power.

The flow circuit 110 is, in some examples, configured to direct the conditioned power to different parts of the auto-configurable UPS 101. For example, the flow circuit 110 may direct a first portion of the conditioned power to the controller 116, a second portion of the conditioned power to the energy-storage interface 114, and/or a third portion of the conditioned power to the second converter 122. The first, second, and third portions of power may be any percentage of the conditioned power, from 0% to 100%.

The second converter 112 is configured to receive conditioned power and convert the conditioned power into output power. The second converter 112 can provide output power having a range of voltages. For example, the second converter 112 may provide first output power having a first output voltage at a first point in time. The second converter 112 may later provide second output power having a second output voltage at a second point in time. In some examples, the second converter 112 may have multiple outputs and may be configured to simultaneously provide output power having different characteristics to the multiple outputs. For example, the second converter 112 may provide output power having one voltage to one output, and may provide output power having a different voltage to a different output. In some examples, the second converter 112 provides the output power to the output 104. In some examples, the second converter 112 is a DC/DC converter, meaning the second converter 112 receives DC power and outputs DC power.

The output 104 is configured to receive power from the second converter 112 and provide power to the load 122. The output 104 may be any type of output, such as a plug, power port, pin, or other type of connection configured to mate with external devices. The output 104 may include more than one output connection, for example, multiple ports, plugs, pins, and so forth.

The energy-storage device 118 and the internal energy-storage device 124 may be devices capable of storing or outputting energy, such as batteries, flywheels, capacitors, and so forth. In some examples, the energy-storage device 118 and the internal energy-storage device 124 may be rechargeable and may be configured to provide energy to the energy storage interface 114 for use by the UPS 101 and/or the load 122.

The energy-storage interface 114 is configured to manage the energy-storage device 118 and/or the internal energy-storage device 124. For example, the energy-storage interface 114 may protect the energy-storage device 118 from unwanted conditions, such as fault conditions, overvoltage conditions, overcurrent conditions, high (or low) temperature conditions, power surges, and so on. The energy-storage interface 114 may also be configured to monitor the energy-storage device 118, including monitoring the state-of-charge (“SOC”) of the energy-storage device 118, the temperature of the energy-storage device 118, charge and discharge depths, ambient conditions such as humidity, input and output currents and voltages, and so forth. In some examples, the energy-storage interface 114 may protect the energy-storage device 118 and/or the internal energy-storage device 124 from being charged beyond a rated level and/or discharged below a rated level. In other examples, the energy-storage interface 114 may include a management system (for example, a battery management system[“BMS”]) for the energy-storage device 118 and/or the internal energy-storage device 124. The energy-storage interface 114 may condition power provided by the energy-storage device 118 and provide the conditioned power to the flow circuit 110. The flow circuit 110 may provide the conditioned power to the second converter 112, and the second converter 112 may convert the conditioned power to correspond to the requirements of the load 122, and then provide the power as output power to the load 122. For example, the second converter 112 may adjust the voltage of the output power and/or conditioned power based on the voltage rating of the load 122.

The controller 116 is configured to control the auto-configurable UPS 101. In some examples, the controller 116 is configured to control the first converter 108, the second converter 112, the flow circuit 110, and/or the energy-storage interface 114. The controller 116 may also be configured to receive signals indicative of characteristics of the input power from the sensors 106. In particular, the controller 116 may be configured to receive a signal indicative of a voltage of the input power from the sensors 106 or directly from the AC/DC converter 120 or other power source. In many examples, the voltage of the input power will be the voltage of the power provided by the AC/DC converter 120 or another power supply coupled to the input 102. The controller 116 may be configured to control the second converter 112 to provide output power having a voltage determined by the controller 116. In some examples, the controller 116 may determine the voltage of the output power based on the voltage of the input power. For example, the input 102 may receive input power having a first voltage. The controller 116 may then determine that the output power should have the same voltage as the input power, and may control the second converter 112 to convert the conditioned power to produce output power having the first voltage, or a voltage within a threshold amount (for example, 10%, 20%, 50%, and so forth) of the first voltage.

In some examples, the AC/DC converter 120 is a power converter that is provided with the load 122. The load 122 may be sold together with the AC/DC converter 120. For example, the load 122 may include a DC load configured to be powered by an AC utility grid. The AC/DC converter 120 may be connected between the AC utility grid and the DC load to convert the AC power from the utility grid to DC power for the load 122.

One example is a computer that comes packaged with a power supply. The computer is a load that requires power, and the power supply is a power converter. In this example, the power supply usually includes a first connection to connect the power supply to a main power source, a second connection to connect the power supply to the computer, and a power conversion circuit to convert the main power from the main power source to power suitable for use by the computer. For example, the power conversion circuit in the computer example may convert AC power to DC power having a voltage that the computer is rated to use. Thus, in many examples, the AC/DC converter 120 can already be configured to provide power to the load 122 that the load 122 is rated to receive and can use.

As a result, the controller 116 can use the voltage of the power provided by the AC/DC converter 120 (or a similar device) to automatically determine a voltage the load 122 is rated to use. In some examples, the controller 116 can use the voltage of the input power at the input 102 to automatically determine the voltage the load 122 is rated to use. In various examples, the sensors 106 may sample the voltage of the power provided by the AC/DC converter 120, and provide the sampled voltage to the controller 116. The controller 116 may control the second converter 112 to provide power having a voltage level based on the sampled voltage (for example, a voltage approximately equal to the sampled voltage). In some examples, the controller 116 (or the auto-configurable UPS 101) may not require additional information about the characteristics of the load 122 to provide the output power rated for use by the load 122.

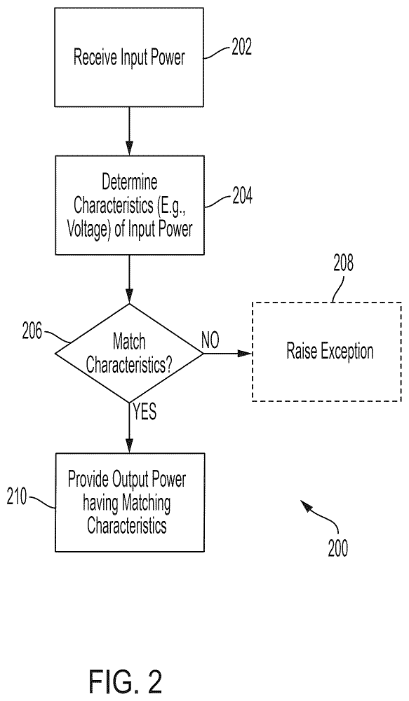

FIG. 2 illustrates a process 200 for providing output power according to an example. The process 200 illustrates one example of how a controller and/or a UPS (or other power system) can determine the characteristics of power rated for use by a load. For example, the process 200 may be executed in connection with the UPS 101. For purposes of example, the process 200 is described below with respect to the UPS 101.

At act 202, the UPS 101 receives input power. The input power may be provided to the input 102 by the AC/DC converter 120. In some examples, the AC/DC converter 120 may be a power supply packaged or shipped with the load 122. The input power may therefore have characteristics that the load 122 is rated to receive. For example, the input power may be at a voltage the load 122 is rated to use. In some examples, the AC/DC converter 120 may derive the input power from mains power received from a utility power grid. The process 200 may then continue to act 204.

At act 204, the controller 116 determines the characteristics of the input power. For example, the controller 116 may determine a voltage, a current, harmonic information, and so forth of the input power. In some examples, the sensor 106 senses at least one characteristic, such as voltage, of the input power and provides a signal indicative of the at least one characteristic of the input power to the controller 116. The process 200 may then continue to act 206.

At act 206, the controller 116 determines whether the UPS 101 can provide output power to the load 122, where the output power has characteristics matching the characteristics of the input power or has characteristics matching, within a threshold amount, the characteristics of the input power. In some examples, the controller 116 may compare the output voltages or output voltage range of the UPS 101 to the voltage of the input power. The output voltages or output voltage range of the UPS 101 may be determined at least in part based on the output capabilities of the second converter 112. For example, if the input power has a voltage level of 50 V, the controller 116 may determine whether the second converter 112 can output power having a voltage of 50 V (or can output power having a voltage within a threshold range of 50 V).

In some examples, the controller 116 may compare any characteristic that the UPS 101 can manipulate or change to the same characteristic of the input power. If the controller 116 determines that the UPS 101 can provide output power having matching characteristics to the load 122 (206 YES), the process 200 continues to act 210. If the controller 116 determines that the UPS 101 cannot provide output power having matching characteristics to the load 122 (206 NO), the process 200 may continue to optional act 208. In other examples, the process 200 may be terminated responsive to act 206—NO, and/or the controller 116 may take other appropriate action.

At optional act 208, the controller 116 raises an exception indicating that the UPS 101 cannot provide output power having characteristics matching or within a threshold amount of the input power characteristics. The exception may include a signal, alert, or other indication of the issue that is provided to a user, a display, and/or an external device and/or network.

At act 210, the controller 116 controls the UPS 101 to provide output power that has characteristics matching or within a threshold amount of the characteristics of the input power. The controller 116 may control, for example, the second power converter 112 to provide the output power. The controller 116 may determine the desired characteristics based on the characteristics sensed at act 204.

In some examples, the process 200 of FIG. 2 may include providing part of the input power to the energy-storage device 118 and/or the internal energy-storage device 124. In other examples, the process 200 of FIG. 2 may include providing part of the power drawn from the energy-storage device 118 and/or the internal energy-storage device 124 to the load 122 and/or the controller 116.

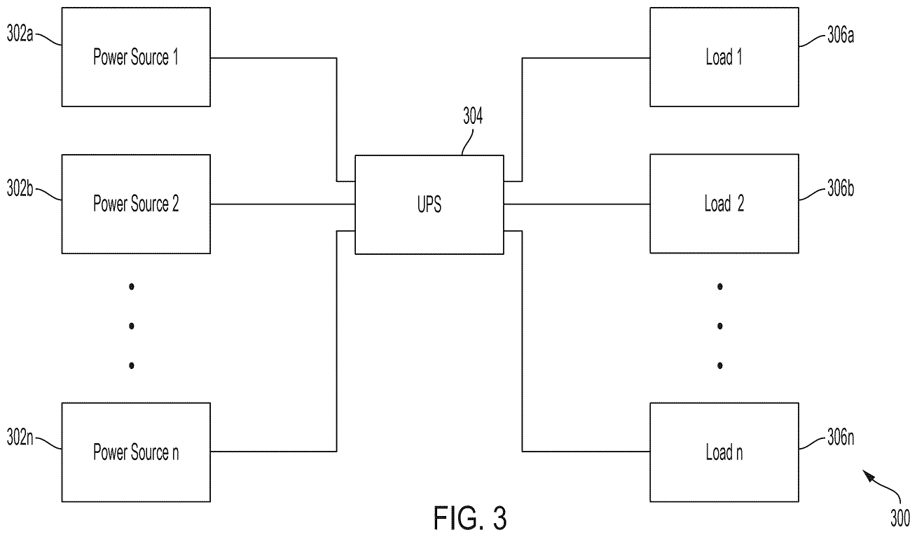

In some examples, the process 200 of FIG. 2 may not be limited to receiving input power from a single source and providing input power to a single load. Instead, the process 200 may also apply to multiple sources of input power, each corresponding to a respective load. FIG. 3 illustrates a block diagram of a power system 300 in accord with this example.

The power system 300 includes an arbitrary number of power sources including a first power source 302a, a second power source 302b, and so on, up to an nth power source, 302n. The power system 300 also includes a UPS 304 and an arbitrary number of loads including a first load 306a, a second load 306b, and so on, up to an nth load 306n. Thus, in some examples, the power system 300 may include an arbitrary number of power sources and an arbitrary number of loads. In some examples, there may be a one-to-one correspondence between power sources and loads.

Each of the power sources 302a-n is coupled to a respective input of the UPS 304. Each of the loads 306a-n is coupled to a respective output of the UPS 304. The UPS 304 may include at least one controller (such as controller 116 of FIG. 1).

As with the auto-configurable UPS 101 of FIG. 1, the UPS 304 can automatically associate a given input power source with a given load. For example, the UPS 304 may include numbered input ports and output ports, such that the first input corresponds to the first output, the second input corresponds to the second output, and so forth. The UPS 304 can detect power characteristics of input power at a given input (for example, the first input), and condition the output power at a given output (for example, the first output) to have one or more power characteristics matching the power characteristics of the input power at the corresponding input.

For example, the first power source 302a may provide input power having a given characteristic (such as voltage). The first power source 302a may be coupled to the UPS 304 via the first input. The first load 302a may be configured to receive power having certain characteristics (such as a given voltage). The UPS 304 may automatically adjust the output power provided at the first output to the first load 306a to match the first input power provided at the first input by the first power source 302a. In some examples, matching the first input power to the first output power may be done in a similar or identical manner to the matching of input and output power described with respect to FIGS. 1 and 2. The UPS 304 may match the second input power provided by the second power source 302b at the second input to the second output power provided at the second output to the second load 306b. The UPS 304 may further match the nth input power provided by the nth power source 302n at the nth input to the nth output power provided to the nth load 306n at the nth output, and so forth.

In some examples, the UPS 304 may include one or more converters coupled to the input and/or output, and each converter may have one or more connections configured to receive input power and/or provide output power. The UPS 304 may also include an energy-storage device for providing output power when one or more of the input power sources 302a-n is not providing power.

The energy-storage device 118 and the internal energy-storage device 124 may include one or more batteries or other type of device capable of storing energy. The energy-storage device 118 and the internal energy-storage device 124 may be rechargeable. The UPS 101 may draw energy stored in the energy-storage device 118 and the internal energy-storage device 124. For example, the second converter 112, the controller 116, the flow circuit 110, and/or the energy-storage interface 114 may draw the energy from the energy-storage device 118 and the internal energy-storage device 124. The energy-storage device 118 and the internal energy-storage device 124 may provide power derived from the stored energy to the auto-configurable UPS 101. The energy-storage device 118 may be modular, such that the energy-storage device 118 can be connected and disconnected from the auto-configurable UPS 101. In some examples, the energy-storage device 118 and/or the internal energy-storage device 124 may include a battery control and energy-storage interface of their own. In some examples, such as those where the energy-storage device 118 and/or the internal energy-storage device 124 include a battery control and energy-storage interface of their own, the energy-storage interface 114 may be omitted from the auto-configurable UPS 101.

Various controllers, such as the controller 116, may execute various operations discussed above. Using data stored in associated memory and/or storage, the controller 116 also executes one or more instructions stored on one or more non-transitory computer-readable media, which the controller 116 may include and/or be coupled to, that may result in manipulated data. In some examples, the controller 116 may include one or more processors or other types of controllers. In one example, the controller 116 is or includes at least one processor. In another example, the controller 116 performs at least a portion of the operations discussed above using an application-specific integrated circuit tailored to perform particular operations in addition to, or in lieu of, a general-purpose processor. As illustrated by these examples, examples in accordance with the present disclosure may perform the operations described herein using many specific combinations of hardware or hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

1. A power system for converting the voltage of DC power comprising:
a DC input configured to receive input DC power having an input voltage from a power source;
a DC output configured to provide output DC power to a load;
power conversion circuitry; and
at least one controller configured to:
control the power conversion circuitry to convert the input DC power into conditioned DC power having a first voltage; and
control the power conversion circuitry to provide the output DC power having a second voltage selected based on the input voltage of the input DC power.

2. The power system of claim 1, the power conversion circuitry comprising:
a first DC/DC converter coupled to the DC input and configured to provide the conditioned DC power; and
a second DC/DC converter coupled to the DC output and configured to provide the output DC power.

3. The power system of claim 2 wherein the second DC/DC converter is configured to be coupled to an energy-storage device, and wherein the at least one controller is configured to control the second DC/DC converter to draw stored energy from the energy-storage device and provide the output DC power derived at least in part from the stored energy.

4. The power system of claim 2 wherein the at least one controller is further configured to control the second DC/DC converter to set a voltage of the output DC power based on the input voltage of the input DC power at the DC input.

5. The power system of claim 2 wherein the at least one controller is further configured to control the second DC/DC converter to provide the output DC power such that the second voltage is within a threshold voltage amount of the input voltage of the input DC power.

6. The power system of claim 1 further comprising a voltage sensor configured to detect a voltage of the input DC power.

7. The power system of claim 1 wherein the second voltage selected based on the input voltage of the input DC power is approximately equal to the input voltage of the input DC power at the DC input.

8. The power system of claim 1 further comprising an energy-storage device, wherein the output DC power is derived from energy stored in the energy-storage device.

9. The power system of claim 1 wherein the power conversion circuitry is configured to provide a first portion of the conditioned DC power to the load and a second portion of the conditioned DC power to an energy-storage device.

10. The power system of claim 1 wherein controlling the power conversion circuitry to convert the input voltage of the input DC power includes controlling a DC/DC converter such that the first voltage of the conditioned DC power is different than the input voltage of the input DC power.

11. The power system of claim 1 wherein the input DC power is received at a voltage level rated for use by the load.

12. The power system of claim 1 wherein the power conversion circuitry is configured to be coupled to an energy-storage device, and wherein the at least one controller is configured to control the power conversion circuitry to provide uninterrupted power derived from the power source or the energy-storage device to the load.

13. A method of providing power to a load, the method comprising:
receiving input DC power;
responsive to receiving input DC power, determining a voltage of the input DC power; and
responsive to determining the voltage:
converting the voltage of the input DC power to a first voltage;
providing output DC power having a second voltage based on the voltage of the input DC power.

14. The method of claim 13 wherein providing the output DC power further comprises:
drawing stored energy from an energy-storage device; and
converting a voltage of the stored energy to provide the output DC power having the second voltage.

15. The method of claim 13 wherein providing the output DC power having the second voltage includes converting the first voltage so that the second voltage is within a threshold voltage amount of the voltage of the input DC power.

16. The method of claim 13 wherein the voltage of the input DC power is rated for use by the load.

17. A non-transitory computer-readable medium storing thereon instructions that, when executed by at least one processor, instruct the at least one processor to:
determine a voltage of input DC power; and
control power conversion circuitry to:
produce conditioned DC power based on the input DC power by converting the voltage of the input DC power to a first voltage for the conditioned DC power; and
provide output DC power, the output DC power having a second voltage based on the voltage of the input DC power.

18. The non-transitory computer-readable medium of claim 17 wherein the instructions instruct the at least one processor to:
control a DC/DC converter to condition the input DC power and provide at least a portion of the conditioned DC power to an energy-storage device.

19. The non-transitory computer-readable medium of claim 17 wherein the instructions instruct the at least one processor to:
control a DC/DC converter to provide the output DC power having the second voltage based on the voltage of the input DC power.

20. The non-transitory computer-readable medium of claim 17 wherein the instructions instruct the at least one processor to:
control a DC/DC converter to set the second voltage of the output DC power to within a threshold amount of the voltage of the input DC power.
